(19) United States
(12) Patent Application Publication
(10) Pub. No.: US 2014/0269786 A1
(43) Pub. Date: Sep. 18, 2014

(54) CONTINUOUSLY VARIABLE PULSE-WIDTH, HIGH-SPEED LASER

(71) Applicant: SPECTRAL ENERGIES, LLC, Dayton, OH (US)

(72) Inventors: Sukesh Roy, Beavercreek, OH (US); Mikhail N. Slipchenko, West Lafayette, IN (US)

(73) Assignee: SPECTRAL ENERGIES, LLC, Dayton, OH (US)

(21) Appl. No.: 13/832,254

(22) Filed: Mar. 15, 2013

(51) Int. Cl. H01S 3/11

(52) U.S. Cl. CPC H01S 3/11
USPC 372/3; 372/26

(57) ABSTRACT

A laser comprises a master oscillator, a modulator, a controller, and an amplifier. The master oscillator has an optical cavity and provides a signal, which may be continuous or pulsed. The modulator resides outside of the optical cavity, receives the signal, and modulates the signal to create a new train of pulses, where the pulses of the train of pulses include a pulse width. The controller, coupled to the modulator, instructs the modulator to control the pulse width of the pulses of the pulse train. The amplifier, optically coupled to the master oscillator, amplifies the train of pulses provided by the modulator.

### BACKGROUND

Various aspects of the present disclosure relate generally to burst-mode lasers and specifically to high-speed, burst-mode lasers.

Burst-mode lasers are used in various applications including high-speed measurements of temperature; mixture fraction; planar laser-induced fluorescence (PLIF) of OH, NO, CH, and CH₂O; and Raman line imaging of O₂, N₂, CH₄, and H₂. These lasers include a continuous wave or pulsed master oscillator which includes an optical cavity and in case of pulsed master oscillator may use Q-switching to create a train of pulses. In Q-switching, modulation occurs within the optical cavity, and the resulting train of pulses may have a variable frequency (i.e., pulse repletion rate). The gain, losses, and length of the optical cavity in a Q-switched oscillator dictates the pulse width of the pulses of the train of pulses.

### BRIEF SUMMARY

According to various aspects of the present disclosure, a laser comprises a master oscillator, a modulator, a controller, and an amplifier. The master oscillator includes an optical cavity and provides a fundamental signal, which may be continuous or pulsed. The modulator resides outside of the optical cavity, receives the signal, and modulates the signal to create a train of pulses, where the pulses of the train of pulses include a pulse width. The controller, coupled to the modulator, instructs the modulator to control the pulse width of the pulses of the pulse train in the case of a continuous signal. The amplifier, optically coupled to the master oscillator, amplifies the train of pulses provided by the modulator.

According to further aspects of the present disclosure, a Raman laser comprises a housing that is less than 0.2 square meters and houses components of the Raman laser. A fiber-pigtailed diode laser generates a continuous fundamental signal that is modulated by an acousto-optic modulator to create a train of pulses, where the pulses of the train of pulses include a pulse width. A controller instructs the acousto-optic modulator to vary the pulse width of the pulses of the train of pulses. Further, a fiber amplifier includes a thirty dB gain and amplifies the train of pulses to have a per-pulse energy of 100 nanojoules per nanosecond. After the train of pulses passes through a first optic isolator, a first diode-pumped amplifier amplifies the train of pulses. The train of pulses passes through a quartz rotator and a spatial filter comprising two spherical lenses and a pinhole. Then, the train of pulses passes through a second diode-pumped amplifier and a quarter wavelength wave plate. There, the train of pulses passes through a spherical lens and reflects off of a phase-conjugate mirror implementing fiber stimulated Brillion scattering. The train of pulses passes back through the spherical lens, second diode-pumped amplifier, spatial filter, quartz rotator, and first diode-pumped amplifier. After passing through a second optic isolator, the wavelength of the train of pulses is shifted by a solid-state Raman shifter.

According to still further aspects of the present disclosure, a method for creating a laser signal is disclosed. A fundamental continuous wave signal is provided and is modulated to create a train of pulses, wherein a pulse of the train of pulses includes a pulse width. The train of pulses is amplified and emitted as the laser signal.

### BRIEF DESCRIPTION OF THE SEVERAL VIEWS OF THE DRAWINGS

FIG. 1 is a block diagram illustrating a continuously variable pulse-width, high-speed laser, according to various aspects of the present disclosure;

FIG. 2 is a block diagram illustrating an exemplary implementation of the continuously variable pulse-width, high-speed laser of FIG. 1, wherein the exemplary implementation is for use in Raman spectroscopy applications, according to various aspects of the present disclosure; and

FIG. 3 is a flow chart illustrating a method for creating a laser signal, according to various aspects of the present disclosure.

### DETAILED DESCRIPTION

According to aspects of the present disclosure, a laser includes a master oscillator within an optical cavity, a modulator residing outside the optical cavity optically coupled to the master oscillator, a controller that controls the modulator, and an amplifier optically coupled to the modulator. The master oscillator generates a signal, which may be pulsed or continuous. In case of pulsed master oscillator the modulator selects any of the pulses from the initial pulse train from master oscillator to create the desired pulse train. In case of a continuous wave master oscillator the modulator modulates the oscillator signal to provide a pulsed signal (i.e., train of pulses), and each of the pulses of the pulsed signal has a pulse width. These pulses can be spaced, for example, anywhere from five nanosecond to tens of milliseconds apart with a pulse width limited only by the space between the pulses and the modulator.

The controller instructs the modulator to control the pulse width of the pulses within the train of pulses. If the master oscillator produces a continuous wave signal, then the modulator can control the pulse width, intensity, and pulse repetition rate as desired. If the master oscillator produces a pulsed signal, then the modulator can alter the pulse width, intensity, and pulse repetition rate based on that pulsed signal. For example, if the pulsed signal has a pulse width of thirty nanoseconds, then the modulator may make the pulse width less than thirty nanoseconds, but not more than thirty nanoseconds. Basically, the modulator can shorten pulse widths by removing a portion of the pulse width and shorten pulse-repetition rates (i.e., lengthen time between pulses) by removing pulses entirely.

Then, the train of pulses is amplified with an amplifier. In some embodiments, the train of pulses passes to a wavelength-tuning module to change the wavelength of the pulses of the train of pulses. Finally, the train of pulses is emitted from the laser as the laser signal.

Turning to the figures, and in particular FIG. 1, a continuously variable pulse-width, high-speed laser 100 includes a master oscillator 110, a modulator 120 controlled by a controller 130, and an amplifier 140.

The master oscillator 110 has an optical cavity and generates a fundamental signal that can be continuous or pulsed. For example, the master oscillator 110 may be a fiber laser with an active gain medium of an optical fiber doped with at least one rare-earth element (e.g., erbium, ytterbium, neodymium, dysprosium, praseodymium, and thulium). A master oscillator 110 that is just a fiber laser without a Q-switch in the optical cavity will produce a signal that is a continuous wave. However, if a Q-switch is placed inside the optical cavity, then the signal generated will be a pulsed signal with a fixed pulse width. As will be described in greater detail herein, the signal eventually propagates through the continuously variable pulse-width, high-speed laser 100 in one form or another (e.g., signal, train of pulses, etc.). In the rest of the disclosure below, it is assumed that the master oscillator produces a continuous wave signal. However, the same principles can be applied to a pulsed signal, limited by the pulses of the pulsed signal as described above.

The modulator 120, which resides outside of the optical cavity, receives the signal from the master oscillator 110 and creates a train of pulses from the signal. Basically, the modulator 120 controls some of the properties of the train of pulses including, but not limited to: the width of the pulses (i.e., pulse width), the pulse repetition rate (i.e., pulse frequency), and the intensity of the pulses. The modulator 120 may be any module that can modulate an optical signal (e.g., acousto-optic modulator (AOM), electro-optic modulator (EOM), directly modulated diode laser, etc.). As such, the modulator 120 may employ amplitude modulation, a polarization modulation, or phase modulation to create the train of pulses from the signal generated by the master oscillator 110.

The controller 130 coupled to the modulator 120 instructs the modulator 120 control the pulse width of the pulses of the pulse train. Further, the controller 130 also may instruct the modulator 120 to control the pulse repetition rate, intensity of the pulses, or both. For example, the modulator 120 receives the signal from the master oscillator 110 and modulates the signal to create a train of pulses with a pulse width of ten nanoseconds with a pulse frequency of one kilohertz (kHz). Then, a user determines that a different pulse width is required and instructs the controller 130 to make the pulse widths larger. As such, the controller 130 instructs the modulator 120 to lengthen the pulse widths of the train of pulses to one hundred nanoseconds, and the modulator 120 does so. Thus, the modulator 120 changes the pulse widths of the pulses in the train of pulses based on instructions from the controller 130 on the fly, without requiring the length (or any other property) of the optical cavity to be physically changed.

To instruct the modulator 120, the controller 130 supplies a control signal from a pulse generator, a function generator, an arbitrary waveform generator, or combinations thereof to the modulator 120. For example, if the modulator 120 is an acousto-optic modulator (AOM), then the controller 130 can supply an electrical signal from a function generator, and that electrical signal passes through a transducer inside the AOM to be converted into an acoustic signal, which modulates the optical signal from the master oscillator 110.

As indicated in the example above, the pulse repetition rate can include a regular repetition rate (e.g., a 1-kHz pulse-frequency with a pulse every millisecond). However, because the flexibility of the controller 130 and the modulator 120 is outside of the optical cavity, the train of pulses may also include an irregular pulse repetition rate. For example, the resulting train of pulses can be two pulses separated by ten microseconds followed by a one-hundred-microsecond interval all of which is repeated. In another example, the resulting train of pulses can be a ten-nanosecond pulse spaced apart from a one-hundred-nanosecond pulse by thirty microseconds, then a forty-microsecond interval followed by a fifty-nanosecond pulse, etc. In other words, a pulse of any pulse width and intensity may be followed by another pulse of any pulse width and intensity with an interval of any length between the pulses and so on. Thus, the modulator 120 placed outside of the optical cavity allows control over the resulting pulse train without limitations imposed by physical characteristics of the optical cavity.

A user can input instructions to the controller 130 in a variety of methods. For example, the user input may be one or more buttons, one or more dials, a computer interface, etc., or combinations thereof. Further, the controller may include preprogrammed set points that discretely vary the pulse widths, pulse intensities, pulse-repetition frequencies, or combinations thereof, with in the controller 130. For example, when a user supplies an input (e.g., selects a button from the set of buttons, changes a position on the dial, enters instructions via the computer interface, etc.) the controller responds with a preprogrammed function (from the pulse generator, function generator, arbitrary waveform generator, etc.) based on the user input.

Moreover, the controller 130 may vary the pulse widths, pulse intensities, and pulse-repetition frequencies with continuous (i.e., non-discrete) functions based on the user input. As such, the pulse widths, pulse intensities, and pulse-repetition frequencies can be varied independently from each other. Further, the controller may use both continuous and discrete methods for controlling the properties of the train of pulses using the modulator 120.

The amplifier 140 may be any topology of amplifier that amplifies the train of pulses created by the modulator 120 from the signal generated by the master oscillator 110. For example, the topology of the amplifier may be a fiber amplifier, a diode-pumped amplifier, a flashpump amplifier, etc. If a diode-pumped or flashpump topology is used, that amplifier may include an amplifier rod of any acceptable material such as Nd:YAG, Nd:glass, Nd:YLF, and Nd:YVO₄. For example, the amplifier rod may be a neodymium-doped yttrium aluminum garnet (Nd:YAG) rod or a neodymium-doped glass (Nd:glass) rod.

The amplifier 140 may be a sole amplifier in the system. Alternatively, the diode-pumped amplifier 140 may be part of a larger amplifier chain. Where an amplifier chain is used to cascade (optically couple) gain stages, each of the amplifiers in the amplifier chain can have similar or different properties and topologies to achieve desired gain characteristics. For example, if the amplifier 140 is part of an amplifier chain with all diode-pumped amplifiers, then the sizes of the rods of the diode-pumped amplifiers may vary depending on the location of the amplifier within the amplifier chain.

All of these components 110, 120, 130, 140, can be contained in a housing that is less than 0.2 square meters (e.g., a length of 0.6 meters, and a width of 0.3 meters).

Further, the laser 100 may include a wavelength-tuning module (not shown) that varies depending on an application of the laser (e.g., high-speed measurements of temperature; mixture fraction; planar laser-induced fluorescence (PLIF) of OH, NO, CH, and CH₂O; and Raman line imaging of O₂, N₂, CH₄, and H₂; etc.). For example, if the laser 100 is used in Raman spectroscopy, then the wavelength-tuning module may include a Raman shifter that produces near-infrared wavelengths that can excite the C—H stretch, the O—H stretch, etc. If the pulse width of the signal emitted from the laser 100 with a Raman shifter penetrates to a certain depth of living tissue and a user wants to penetrate to a different depth, then the user enters an input into the laser 100, and the controller 130 instructs the modulator 120 to change the pulse width of the pulses in the pulse train, based on the user input.

FIG. 2 illustrates an exemplary laser 200 for use in Raman spectroscopy. The laser 200 is shown including several reflectors (e.g., mirrors) 202 to allow the laser to fit into a relatively small housing. However, such reflectors 202 are not required for proper operation of the laser; they are included only to give a specific shape to the housing. For example, the exemplary laser 200 can fit into a 2-foot×1-foot (approximately 0.6-meter×0.3-meter (area of less than 0.2 square meters)) housing. The components (described below) are optically coupled as shown in FIG. 2, except where indicated.

A master oscillator 204 is provided, which is analogous in function to the master oscillator 110 of FIG. 1. More particularly, the master oscillator 204, which contains an optical cavity 206, includes a fiber-pigtailed diode laser 204 that generates a continuous fundamental signal at 1064.3 nanometer (nm) with 0.1 Watts of power.

To form a train of pulses from the signal, the signal generated by the fiber-pigtailed diode laser 204 is directed into a modulator 208, which is analogous in function to the modulator 120 of FIG. 1. As mentioned above, the modulator 208 is communicably coupled to (e.g., electrically, wirelessly, optically, etc.) and controlled by a controller 210, which is analogous in function to the controller 130 of FIG. 1. The exemplary modulator 208 is an acousto-optic modulator with a rise time of several nanoseconds, and a fall time of several nanoseconds, and a high extinction ratio (approx. 10⁶), which serves to completely suppress the continuous wave background from the master oscillator 204 so that the train of pulses can be amplified to a high level during amplification.

The train of pulses then feeds an ytterbium-doped fiber amplifier 212 with 30 dB (decibels) gain to amplify the train of pulses at a wavelength of 1064.3 nm to include a per pulse energy of one-hundred nanojoules per one ns of pulse duration (i.e., pulse width). The fiber amplifier 212 includes a polarization-maintaining large-mode-area fiber, which results in a Gaussian beam profile with an M² factor of 1.3.

The output of the fiber amplifier is collimated with a lens 214 and fed to a first optic isolator 216, which feeds a first amplifier 218. The exemplary first amplifier 218 is a 2-mm diameter Nd:YAG-rod diode-pumped amplifier and is fired at a one-kilohertz repetition rate to amplify the train of pulses. The train of pulses then passes through a quartz rotator 220 to compensate for thermally induced birefringence.

To prevent build-up of amplified spontaneous emission (ASE), a spatial filter 222 is located after the first amplifier 218. The spatial filter 222 includes a first spherical lens 224 that focuses the train of pulses to a pinhole 226, and a second spherical lens 228 disperses and collimates the train of pulses at the pinhole 226. The output of the spatial filter 222 feeds a second amplifier 230. In this example laser 200, the second amplifier 230 is identical to the first amplifier 218; however, such identity is not required.

The output of the second amplifier 230 feeds a quarter-wavelength wave plate 232 and a spherical lens 234. A phase-conjugate mirror 236 is setup after a single pass through the first and second amplifiers 218, 230 to remove built up ASE and is based on a stimulated Brillion scattering (SBS) effect in multimode fiber. After hitting the phase conjugate mirror 236, the train of pulses passes through the first and second amplifiers 218, 230 in the opposite direction so the amplifiers 218, 230 may amplify the train of pulses a second time. Then, a polarization beam splitter 238 (e.g., a thin film polarizer) directs the train of pulses to a second optic isolator 240.

The train of pulses then feeds a Raman shifter 242 in an optical cavity bound by an end mirror 244 and an output coupler 246. The Raman shifter 242 can be any device that shifts the fundamental wavelength of the train of pulses (e.g., 1064.3 nm) to a wavelength corresponding to an integer number of Raman modes (Stokes) of the material used (e.g., 1197 nm as a first Stokes of Barium Nitrate pumped by 1064 nm, 1726 nm as a fourth Stokes of potassium gadolinium tungstate pumped by 1064 nm, etc.). For example, the Raman shifter 242 may be a solid-state Raman shifter such as a 60-mm (millimeter) KGW (potassium gadolinium tungstate) crystal or 60-mm Ba(NO₃)₂ (Barium Nitrate) crystal.

Incorporation of solid state Raman shifter for wavelength conversion is more robust when compared to parametric wavelength conversion. For example, the solid state Raman shifter does not require crystal angle or temperature tuning compared to parametric wavelength frequency conversion. The first Stokes of Ba(NO₃)₂ can excite the second overtone of the C—H stretch, while third Stokes of KGW can reach the O—H combination band, and the fourth Stokes of KGW can be used for excitation of the first vibrational overtone of C—H.

The shifted train of pulses passes through a prism 248 to separate wavelengths and exits the exemplary Raman laser 200. The variable pulse-duration Raman laser 200 offers one-kilohertz operation with more than one millijoule of energy per pulse in near infrared wavelengths and a pulse duration variable from five to one hundred nanoseconds. Applications for this laser 200 include, but are not limited to: high-speed photoacoustic microscopy and endoscopy and allows excitation of C—H and O—H vibrational overtones in the range from 1197 to 1726 nm with variable pulse duration for optimal penetration depth and axial resolution.

Turning to FIG. 3, a method 300 for creating a laser signal is shown. At 310, a fundamental signal is provided from within an optical cavity. This fundamental signal may be a continuous wave signal or a pulsed signal and will be used to derive the laser signal. Further, the fundamental signal may be of any desired wavelength.

At 320, the fundamental signal is modulated to create a train of pulses, and the pulses of the train of pulses include a pulse width. For example, the pulses in the train of pulses may have a pulse width of ten nanoseconds. Moreover, the modulation occurs outside of the optical cavity from which the fundamental signal is provided. As mentioned above, the fundamental signal may be modulated based on an electrical signal from a pulse generator, a function generator, or an arbitrary waveform generator. If the component performing the modulation is an AOM, then the electrical signal is changed to an acoustic signal in the AOM.

Further, the modulation of the fundamental signal to create the train of pulses may be altered. For example, the pulse width of the pulses in the train of pulses may be altered by a controller controlling the component performing the modulation. Other properties of the train of pulses (e.g., pulse intensity, and pulse-repetition frequency, etc.) may also be altered. For example, if the fundamental signal is originally modulated such that the pulses of the train of pulses have a pulse width of ten nanoseconds, then the pulse width may be altered to a different pulse width such as one hundred nanoseconds. As mentioned above, the pulses of the train of pulses may be altered on an individual basis to obtain an irregular pulse frequency, irregular pulse width, irregular intensity, or combinations thereof.

At 330, the train of pulses is amplified by a single amplifier or an amplifier chain. For example, the train of pulses can pass through a diode-pumped amplifier, a flashpump amplifier, or both. In addition, the train of pulses may be amplified by a fiber amplifier disposed prior to other amplifiers. For example, the fiber amplifier can include a thirty dB gain and can convert the continuous signal to a train of pulses with a per-pulse energy of 100 nanojoules per nanosecond.

At 340, the train of pulses is emitted as the laser signal. Before being emitted, the train of pulses may have its wavelength shifted to another wavelength.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Aspects of the disclosure were chosen and described in order to best explain the principles of the disclosure and the practical application, and to enable others of ordinary skill in the art to understand the disclosure for various embodiments with various modifications as are suited to the particular use contemplated.

What is claimed is:

1. A laser comprising:
a master oscillator including an optical cavity, wherein the master oscillator provides a fundamental signal;
a modulator outside the optical cavity, wherein the modulator receives the fundamental signal and modulates the fundamental signal to create a train of pulses, and pulses of the train of pulses includes a pulse width;
a controller coupled to the modulator, wherein the controller instructs the modulator to control the pulse width of the pulses of the pulse train; and
an amplifier optically coupled to the modulator, wherein the amplifier amplifies the train of pulses provided by the modulator.

2. The laser of claim 1, wherein:
the controller includes a select one of: pulse generator, function generator, and arbitrary waveform generator.

3. The laser of claim 1, wherein:
the controller includes a processor that instructs the modulator to control the pulse width of the pulses based on a user input.

4. The laser of claim 3, wherein the processor instructs the modulator to control the pulse width based on preprogrammed set points that indicate preprogrammed pulse widths.

5. The laser of claim 1, wherein the master oscillator is a continuous wave master oscillator.

6. The laser of claim 1, wherein the modulator is an acousto-optic modulator.

7. The laser of claim 1, wherein the modulator is an electro-optic modulator.

8. The laser of claim 1, wherein the modulator further modulates a pulse repetition rate of the train of pulses.

9. The laser of claim 1, wherein the modulator modulates the signal to create a train of pulses including an irregular pulse repetition rate.

10. The laser of claim 1 further including a solid-state Raman shifter optically coupled to the amplifier, wherein the solid-state Raman shifter produces near infrared wavelength of light.

11. The laser of claim 10, wherein the solid-state Raman shifter produces a near infrared wavelength that can excite a C—H stretch.

12. The laser of claim 10, wherein the solid-state Raman shifter produces a near infrared wavelength that can excite an O—H stretch.

13. The laser of claim 1 further including a fiber amplifier disposed between the modulator and the amplifier.

14. The laser of claim 1 further including a housing that houses the master oscillator, the modulator, the controller, and the amplifier; wherein the housing is less than 0.2 square meters.

15. A Raman laser comprising:
a housing that is less than 0.2 square meters;
a fiber pigtailed diode laser that generates a continuous-wave signal;
an acousto-optic modulator optically coupled to the diode laser, wherein the acousto-optic modulator modulates the continuous-wave signal to produce a train of pulses, wherein the pulses of the train of pulses each have a pulse width;
a controller communicably coupled to the acousto-optic modulator, wherein the controller instructs the acousto-optic modulator to vary the pulse width of the pulses of the train of pulses;
a fiber amplifier optically coupled to the acousto-optic modulator, wherein the fiber amplifier includes a thirty dB gain and amplifies the train of pulses to have a per-pulse energy of 100 nanojoules per nanosecond;
a first optic isolator optically coupled to the fiber amplifier;
a first diode-pumped amplifier optically coupled to the first optic isolator;
a quartz rotator optically coupled to the first diode-pumped amplifier;
a spatial filter optically coupled to the quartz rotator, the spatial filter comprising:
a first spherical lens;
a pinhole;
a second spherical lens;
a second diode-pumped amplifier optically coupled to the spatial filter;
a quarter wavelength plate optically coupled to the second diode-pumped amplifier;
a third spherical lens optically coupled to the quarter wavelength plate;
a mirror optically coupled to the third spherical lens;
a second optical isolator optically coupled to the first diode-pumped amplifier; and
a solid state Raman shifter optically coupled to the second optical isolator.

16. A method for creating a laser signal, the method comprising
providing a continuous wave fundamental signal;
modulating the continuous wave fundamental signal to create a train of pulses, wherein a pulse of the train of pulses includes a first pulse width;
amplifying the train of pulses; and
emitting the amplified train of pulses.

17. The method of claim 16 further including altering the continuous wave fundamental signal to create a train of pulses with a pulse width of a second pulse width different than the first pulse width, wherein the altering occurs outside on the optical cavity from which the laser signal is provided.

18. The method of claim 17, wherein:
modulating the continuous wave fundamental signal to create a train of pulses further comprises modulating the continuous wave fundamental signal to create a train of pulses, wherein the pulses of the pulse train include a pulse width of around ten nanoseconds; and
altering the pulse width to a second pulse width further comprises altering the pulse width of the continuous wave fundamental signal to produce a pulse train with pulses including a pulse width of around one hundred nanoseconds.

19. The method of claim 16, wherein:
modulating the continuous wave fundamental signal further comprises modulating the fundamental signal based on an electrical signal from a select one of: pulse generator, function generator, and arbitrary waveform generator.

20. The method of claim 16 further including amplifying the train of pulses with a fiber amplifier disposed prior to the diode-pumped amplifier, wherein the fiber amplifier includes a thirty dB gain and amplifies the train of pulses to include a per-pulse energy of 100 nanojoules per nanosecond.
